(19) United States
(12) Patent Application Publication
(10) Pub. No.: US 2014/0152955 A1
(43) Pub. Date: Jun. 5, 2014

(54) OPTICAL APPLIANCE

(71) Applicant: Mikromati, LLC, Tenafly, NJ (US)

(72) Inventors: Nancy Papageorgiou, Tenafly, NJ (US); Christopher D. Goodman, Beaverton, OR (US)

(73) Assignee: Mikromati, LLC, Tenafly, NJ (US)

(21) Appl. No.: 14/095,790

(22) Filed: Dec. 3, 2013

Related U.S. Application Data
(60) Provisional application No. 61/733,030, filed on Dec. 4, 2012.

(51) Int. Cl. G02C 3/04; G02B 7/02; G02C 3/00

(52) U.S. Cl. CPC G02C 3/04; G02C 3/006; G02B 7/02
USPC 351/159.52; 359/819; 351/178

(57) ABSTRACT

Disclosed is an optical appliance for mitigating farsighted vision in humans. The optical appliance includes a body portion and a lens portion. The lens portion is coupled to the body portion, and the lens portion is transparent. The lens portion has appropriate optical power to improve a user's visual acuity of near objects when the user looks through the lens portion. In some embodiment, a perimeter of the body portion is kidney-shaped. In some embodiments, the body portion comprises an orientation feature. In some embodiments the body portion includes a lens opening extending through the body portion. In some embodiments, the lens includes a lens retention rim along an outer perimeter of the lens. The lens is coupled to the body portion in response to the lens retention rim begin placed between at least one top lens retention ridge and at least one bottom lens retention ridge.

### CROSS REFERENCE TO RELATED APPLICATION

This application is a continuation of U.S. Patent Application No. 61/733,030 to Papageorgiou, et al., filed Dec. 4, 2012 and entitled “Optical Appliance,” which is incorporated entirely herein by reference.

### BACKGROUND OF THE INVENTION

1. Technical Field

This invention relates to optical appliances and in particular to a handheld optical appliance for aiding farsighted vision in humans.

2. State of the Art

Farsightedness, or the inability—or difficulty—to focus on near objects, is a common vision problem in humans. A tool often used to mitigate farsightedness is a pair of reading glasses. Reading glasses include lenses that work with the lens of the eye to bring the focus of near object images from behind the retina to the retina so that the person's brain can “see” the image clearly.

However, there are a number of shortcomings with reading glasses. One is that using reading glasses in a public setting such as a restaurant, or the like, may give the user the feeling that they appear older than they would like to appear to those around them. The cumbersome nature of glasses—removing them from a purse, pocket, or case; unfolding the temple pieces; and positioning the rather large device on the user's nose—may tend to make using reading glasses in public very conspicuous.

Other devices have been used to help people see clearly. For example, magnifying glasses are commonly used to improve visual acuity for small items such as stamps, gems, and the like. However, magnifying glasses typically have a magnifying power much greater than the lenses of reading glasses and tend to have a relatively small field of view. Magnifying lenses do not function to bring the focal point of the image to the retina. They simply function to scale up the size of an image.

In addition, the magnification of a magnifying glass depends upon its position between the user's eye and the object being viewed, and they are configured to be held at a significant distance from the eye. As a result using a magnifying lens to view near objects is awkward and quite conspicuous in a public setting. Magnifying lenses usually also have unwieldy handles and are poorly balanced.

Both reading glasses and magnifying lenses can be large and unwieldy to carry around and conspicuous to use. Additionally, they are often forgotten by people when they leave home. Being left unable to read a menu, form, or receipt is often the person's first reminder that they don't have their reading glasses. What is needed is an optical appliance for overcoming farsightedness that can be easily transported with an individual, be easily and discreetly held in the hand for use, and be confidently shared, easily stored, and comfortably balanced in the user's hand.

### BRIEF DESCRIPTION OF THE DRAWINGS

FIG. 1 is a front view of optical appliance 10 being held in hand 190 for use.

FIG. 2 is a front view of optical appliance 10 of FIG. 1.

FIG. 3 is a front view of body portion 112.

FIG. 4 is a side view cross section of optical appliance 10 taken at section 4-4 of FIG. 2.

FIG. 5 is a side view cross section of optical appliance 10 taken at section 5-5 of FIG. 2.

FIG. 6 is a side view cross section of optical appliance 10 taken at section 6-6 of FIG. 2

FIG. 7 is a front view of lens portion 20.

FIG. 8 is a side view cross section of lens portion 20 taken at section 8-8 of FIG. 7.

FIG. 9 shows a front view of a pat of body portion 112.

FIG. 10 shows a side view cross section of lens portion 20 being snapped into body portion 112.

FIG. 11 shows a side view cross section of lens portion 20 that has been snapped into body portion 112.

FIG. 12 shows a close-up perspective view of a portion of body portion 112 and lens opening perimeter 122.

FIG. 13 shows a front view perspective of optical appliance 310.

FIG. 14 illustrates method 200 of forming an optical appliance according to the invention.

### DETAILED DESCRIPTION OF EMBODIMENTS OF THE INVENTION

Human visual system farsightedness, which is the inability or difficulty to focus on near objects, is often brought on by age and is usually seen as a sign of age. Advanced age is sometimes a source of insecurity, thus individuals often do not want to draw attention to their farsightedness.

A common tool to mitigate farsightedness and improve visual acuity of near objects is a pair of reading glasses. Reading glasses include lenses that work with the lens of the eye to bring the focus of near object images from behind the retina to the retina so that the person's brain can “see” the image clearly. However, there are a number of shortcomings with reading glasses. One is that using reading glasses in a public setting such as a restaurant, or the like, may give the user the feeling that they appear older than they would like to appear. The cumbersome nature of glasses—removing them from a purse, pocket, or case; unfolding the temple pieces; and positioning the rather large device on the user's nose—may tend to make using reading glasses in public very conspicuous.

Another shortcoming of reading glasses is that they are often forgotten by people when they leave home. Being left unable to read a menu, form, or receipt is often the person's first reminder that they don't have their reading glasses. Their cumbersome nature also tends to make them difficult to keep with the person, often requiring relatively large cases to protect their fragile construction.

Other devices have been used to help people see things. For example magnifying glasses are commonly used to better view details of objects like stamps, gems and the like. However, magnifying glasses typically have a magnifying power much greater than the lenses of reading glasses, and tend to have a relatively small field of view. Magnifying lenses do not function to bring the focal point of the image to the retina. They simply function to scale up the size of an image.

In addition, the magnification of a magnifying glass depends upon its position between the user's eye and the object being viewed, and magnifying glasses are configured to be held at a significant distance from the eye. As a result using a magnifying lens to view near objects is awkward and quite conspicuous in a public setting. Magnifying glasses also have unwieldy handles and are poorly balanced.

Monocles and quizzing glasses have also been used in the past to help people see more clearly. Monocles have the shortcoming that they must be wedged into the orbit of the eye, making them conspicuous. Additionally, since they are worn so close to the eye, monocles must be kept clean, making them unsuitable for occasional use, casual storage, transport and sharing. A “quizzing glass” is a single magnifying lens on a handle configured to be held up in front of the eye to enable closer scrutiny of an object. Quizzing glasses were meant to be conspicuous, often worn and used as an accessory or piece of jewelry. Today, monocles and quizzing glasses are unlikely to be worn or used in public.

Disclosed is an optical appliance that can be easily carried and stored, and that can be used discreetly by an individual to improve visual acuity of near objects. The optical appliance can be comfortably positioned and balanced in the users hand and held a comfortable distance from the eye while providing a wide field of view. Embodiments of the optical appliance can easily be provided with advertising printing or logos, making them suitable for businesses to give away as gifts or marketing items.

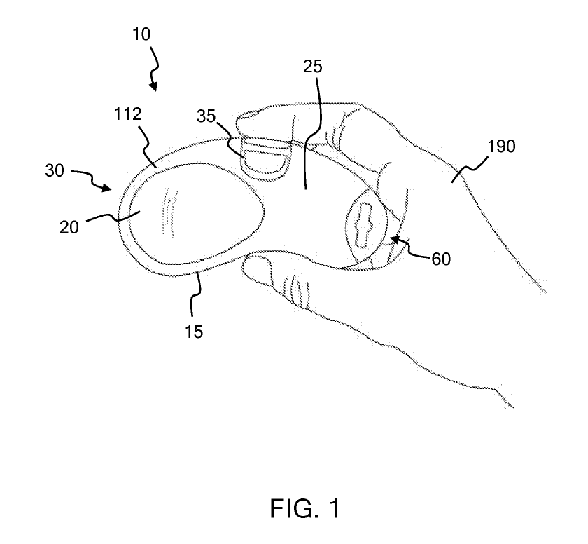

FIG. 1 shows the use of optical appliance 10 according to the invention. Optical appliance 10 includes body portion 112 and lens portion 20 (also referred to as lens 20). Optical appliance 10 is positioned in hand 190 in FIG. 1 such that the user is looking through lens portion 20 to view near items. A viewer looks through lens portion 20 to aid the viewer's visual acuity when viewing the near items.

Lens portion 20 has an appropriate optical power to improve the user's visual acuity of near objects when looking through lens 20. Lens 20 is configured to refract, or redirect, light in a way to work with a user's eye to focus an image of a near object onto the retina of the eye. In some embodiments optical appliance 10 is configured to be held at a distance from the eye which is greater than a typical distance that a reading glass lens is positioned from the eye, but is closer than a typical magnifying lens would be held in front of the face of a user. For example, in some embodiments optical appliance 10 is held approximately 2-12 inches from the eye. In this way optical appliance 10 is used comfortably, quickly, and discretely. In some embodiments optical appliance 10 is used in conjunction with a user's existing prescription glasses. In some embodiments optical appliance 10 is held at a distance from the eye that avoids collecting germs, which minimizes the transmission of germs from a first user to a second user. In some embodiments lens 20 is configured with a diopter that is different from a typical pair of prescription reading glasses for a given individual due to the different relative lens/object lens/eye distances and consequent different focal lengths.

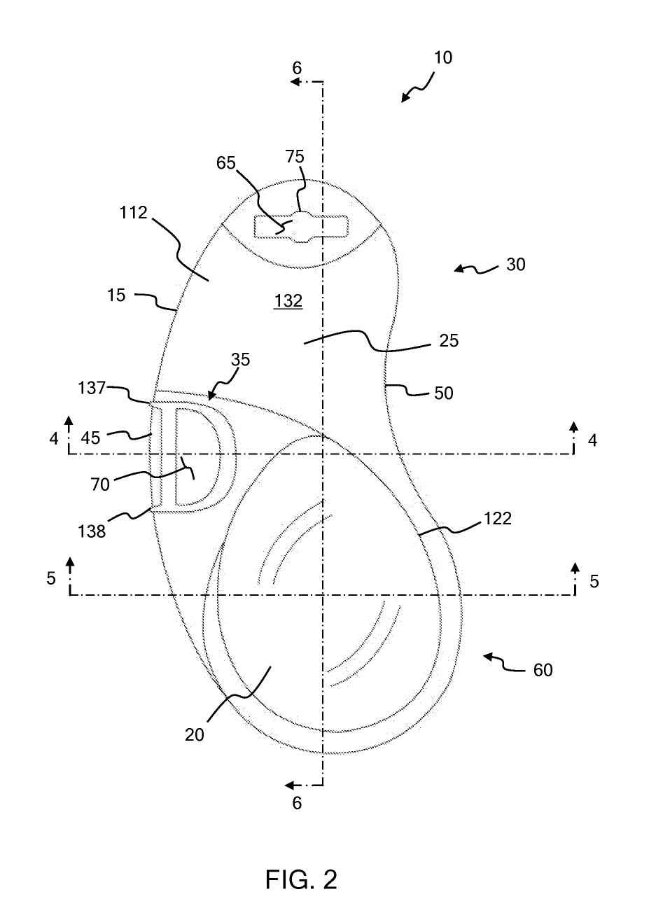

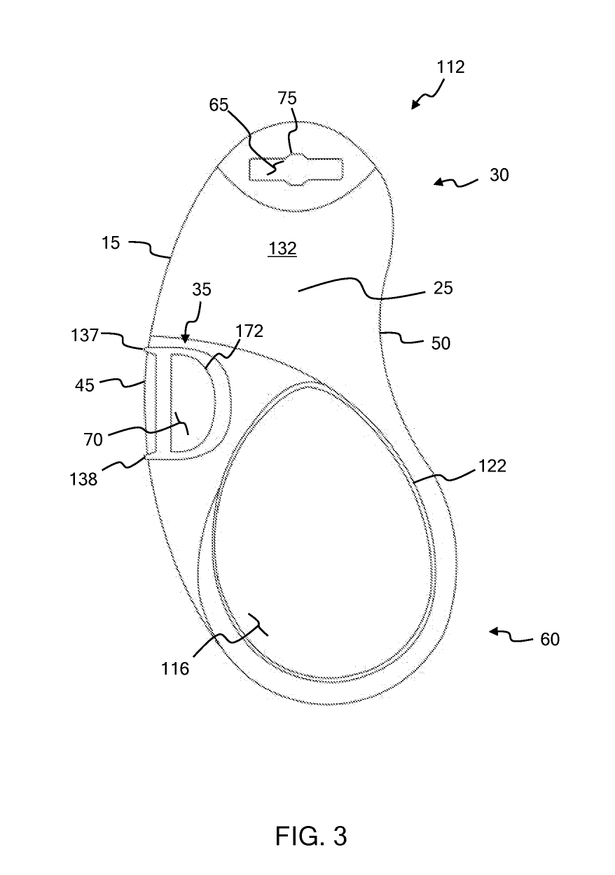

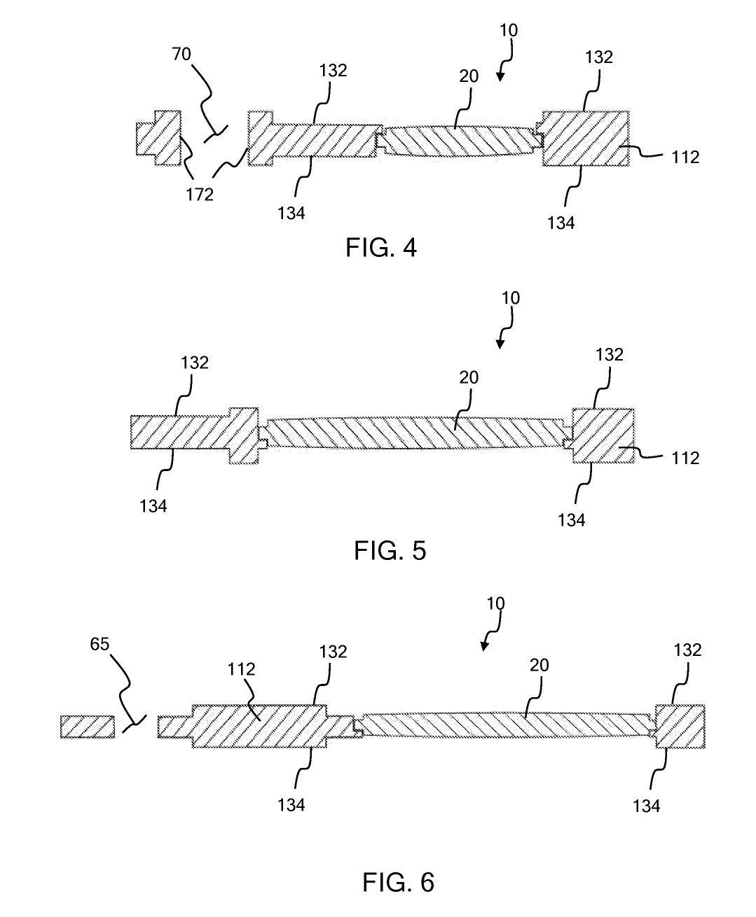

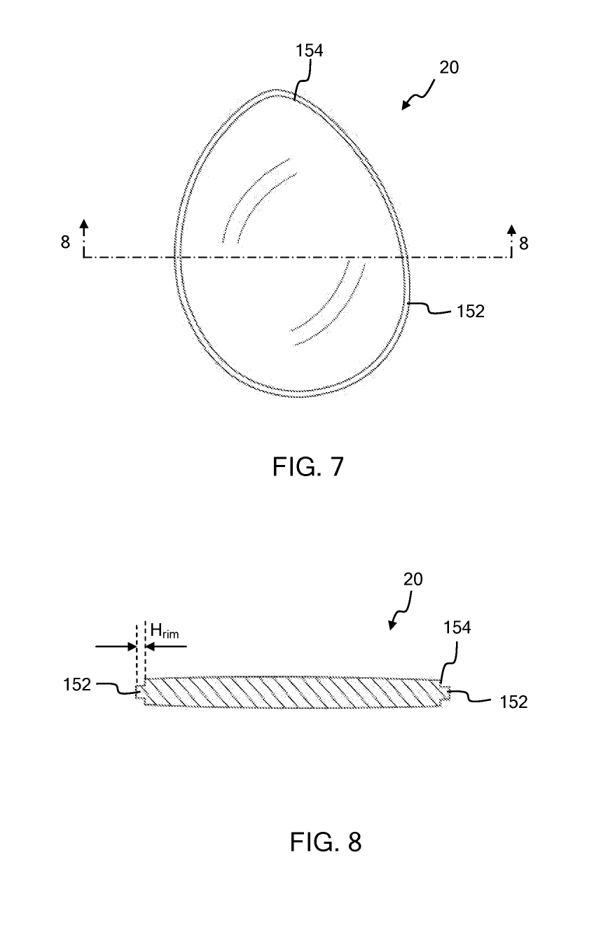

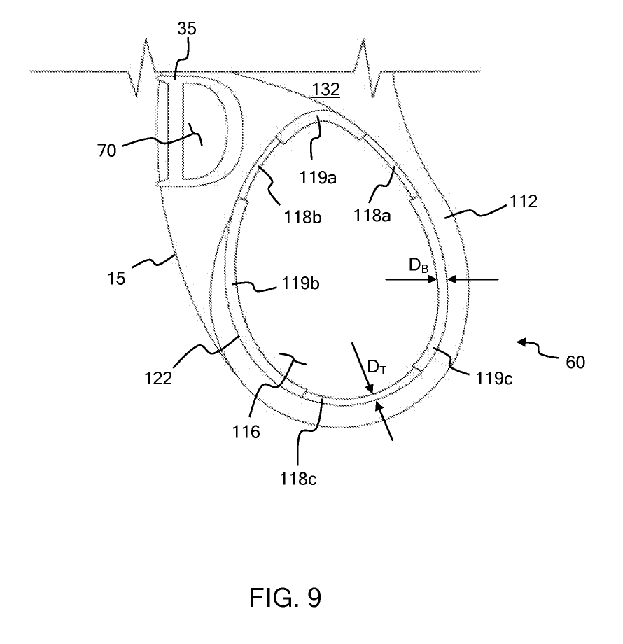

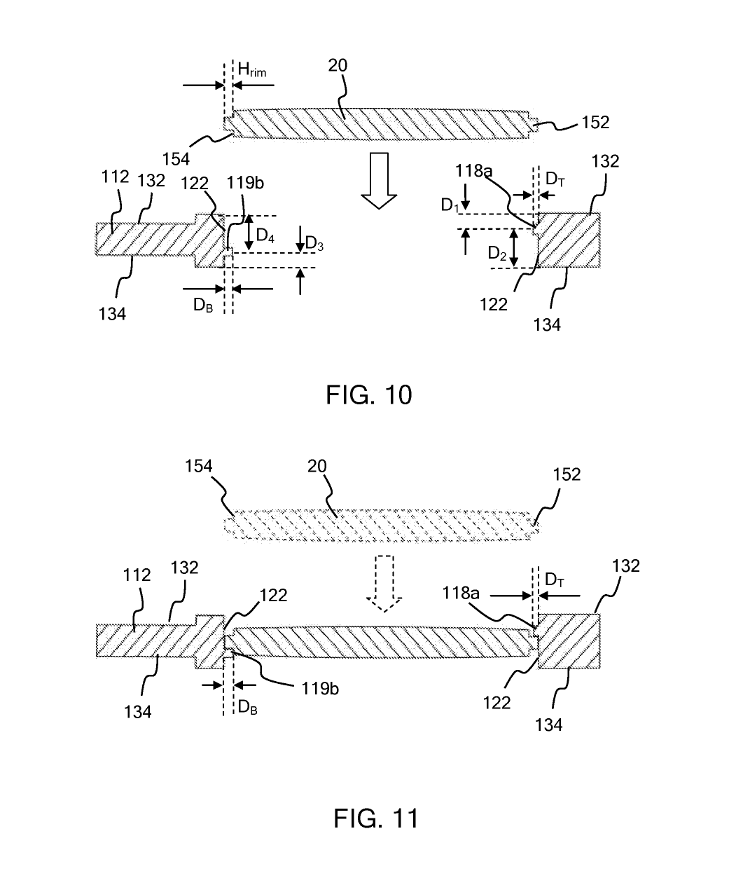

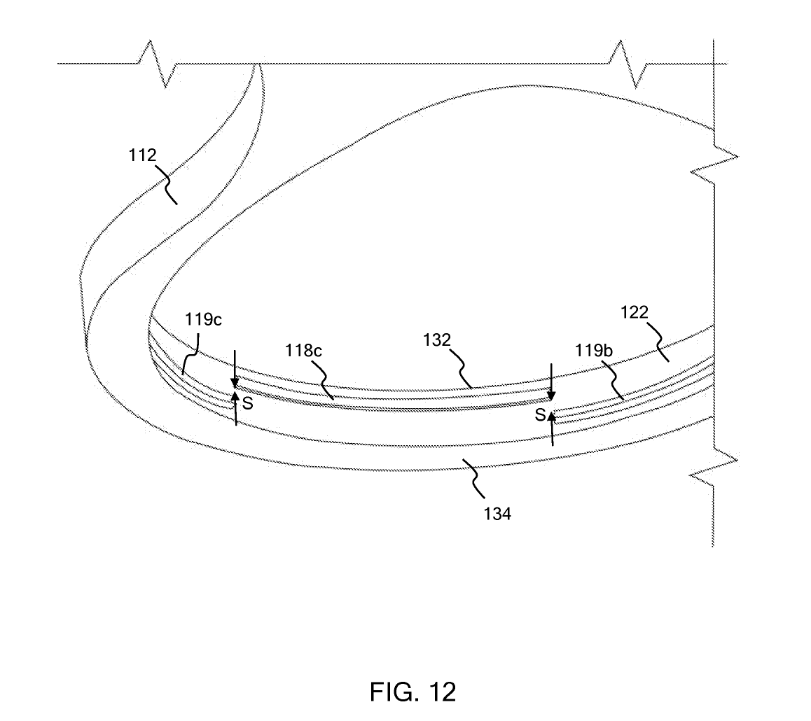

FIG. 2 through FIG. 12 show various views of optical appliance 10 of FIG. 1. FIG. 2 shows a front view of optical appliance 10. FIG. 3 shows a front view of body portion 112. FIG. 4 shows a cross section of optical appliance 10 taken at section 4-4 of FIG. 2. FIG. 5 shows a cross section of optical appliance 10 taken at section 5-5 of FIG. 2. FIG. 6 shows a cross section of optical appliance 10 taken at section 6-6 of FIG. 2. FIG. 7 shows a front view of lens portion 20. FIG. 8 shows a side view cross section of lens 20 taken at section 8-8 of FIG. 7. FIG. 9 shows a part of body portion 112, with top lens retentions ridges 118a, 118b, and 118c, and bottom lens retention ridges 119a, 119b, and 119c drawn with depths larger than actual scale to show their size relative to each other. FIG. 10 and FIG. 11 show a side-view cross section of lens portion 20 being coupled to body portion 112. FIG. 12 shows a close up of a portion of lens opening perimeter 122 of body portion 112, showing top lens retention ridge 118c and bottom lens retention ridges 119b and 119c that are coupled to lens opening perimeter 122.

Optical appliance 10 includes body portion 112 and lens portion 20. Body portion 112 (FIG. 3) has perimeter 15. Perimeter 15 has a front view that is kidney-shaped in the embodiment shown in the figures, but this is not meant to be limiting. In some embodiments, body portion 112 has a front view that is a shape other than kidney-shaped. However, a kidney-shaped body portion 112 has been shown to be easy to grasp with the hand, and allows for tactile determination of the orientation of optical appliance 10. Body portion 112 has butt end 30 and distal end 60. The kidney shape has advantages in that butt end 30 can be held against the palm of the hand, allowing the fingers to hold butt end 30 in many different ways, one of which is shown in FIG. 1. Optical appliance 10 may be held in a way that butt end 30 may be held near or against the user's palm while the user's fingers grasp optical appliance 10, either on or by perimeter 15, or by pinching body portion 112. In this way, optical appliance 10 may be held in a partially concealed way which may include a portion of the skin between the user's thumb and index finger covering up part of optical appliance 10. When butt end 30 is held with the fingers or hand, distal end 60 and lens portion 20 are left unobstructed for easy viewing through lens portion 20.

Kidney-shaped perimeter 15 of body portion 112 includes concave curve 50 (FIG. 2 and FIG. 3), which is a convenient location to place the thumb when grasping optical appliance 10. Kidney-shaped perimeter 15 of optical appliance 10 also includes convex curve 45 (FIG. 2 and FIG. 3) which, in this embodiment includes orientation feature 35 (to be discussed shortly). Orientation feature 35 provides a good gripping surface for an index finger to be placed securely on convex curve 45.

Lens portion 20 is coupled to body portion 112. Lens portion 20 has lens perimeter 154 (FIG. 7 and FIG. 8). In the embodiment of optical appliance 10 shown in the figures, lens portion 20 has lens perimeter 154 that is oval-shaped in front view, but this is not meant to be limiting. In some embodiments of optical appliance 10, lens portion 20 has a shape other than oval. The oval shape of lens perimeter 154 provides a wide area of lens 20 near distal end 60 for viewing, while reducing the area of lens 20 towards butt end 30. It is to be understood that body portion 112 and lens portion 20 can have perimeters with many different shapes. Body portion 112 can have a perimeter 15 with a curvilinear shape, a rectilinear shape, or any other shape. Lens portion 20 can have a lens perimeter 154 with a curvilinear shape, a rectilinear shape, or any other shape.

Lens portion 20 includes lens retention rim 152. Lens portion 20 is coupled to body portion 112 using lens retention rim 152. Lens retention rim 152 is coupled to lens perimeter 154, and protrudes from lens perimeter 154 as shown in FIG. 7 and FIG. 8. Lens retention rim 152 extends along and protrudes from the complete length of lens perimeter 154 in this embodiment. In this embodiment, lens portion 20 is coupled to body portion 112 in response to lens retention rim 152 being positioned between upper lens retention ridge 118 and lower lens retention ridge 119 as will be described shortly. Len retention rim 152 has height Hᵣᵢₘ. In some embodiments, Hᵣᵢₘ is between 0.02 inches and 0.03 inches in height. This range of heights for Hᵣᵢₘ has been determined to provide a secure coupling to body portion 112 without adding to the size, manufacturing cost, or expense of lens portion 20. In some embodiments, Fᵣᵢₘ is about 0.022 inches in height, plus or minus manufacturing tolerances. This specific value for Hᵣᵢₘ optimizes the manufacturing time and cost of lens portion 20 while providing a lens retention rim height Hᵣᵢₘ which securely couples lens portion 20 to body portion 112.

Body portion 112 of optical appliance 10 includes indicia field 25 (FIG. 2 and FIG. 3). Indicia field 25 is configured to receive indicia to identify, for example, the name of a restaurant, doctor's office, or other establishment. In this way the establishment may provide use of optical appliance 10 and also receive a business benefit if the patron does not return optical appliance 10 or receives it as a complementary item. The indicia located on indicia field 25 may provide an element of marketing or advertising for the establishment that provides optical appliance 10.

Body portion 112 includes lens opening 116 (FIG. 3). Lens opening 116 extends through body portion 112. Lens opening 116 is defined by lens opening perimeter 122 (FIG. 3 and FIG. 9 through FIG. 12). Lens opening perimeter 122 includes one or more than one upper lens retention ridge 118 (FIG. 9 through FIG. 12) coupled to lens opening perimeter 122, and one or more than one lower lens retention ridge 119 (FIG. 9 through FIG. 12) coupled to lens opening perimeter 122 which will be discussed in further detail shortly.

Optical appliance 10 includes one or more than one orientation feature 35 (FIG. 2 and FIG. 3). Orientation features 35 according to the invention are a surface feature, protuberance, texture, or other feature formed into or attached to body portion 112 or perimeter 15, which make optical appliance 10 easier to hold and to orient. Orientation features 35 enable a user to discretely retrieve optical appliance 10 from a pocket, purse, feel for orientation features 35, and confidently hold the device in front of his/her eye in a known and comfortable orientation without having to visually inspect optical appliance 10 to determine the orientation. Orientation features 35 may be tactile bumps, for example. Orientation features 35 also make optical appliance 10 easier to hold. In some embodiments, orientation features 35 may include a ridge, or friction surface on perimeter 15 to increase hold-ability of optical appliance 10. This may be particularly important to an elderly user or to persons with difficulty holding things. Orientation features 35 may also provide a pleasing and/or reassuring tactile quality in juxtaposition with an otherwise smooth perimeter 15. Orientation features 35 allow optical appliance 10 to be oriented correctly and securely held in the hand, minimizing fingers slipping off of optical appliance 10 and minimizing having to re-orient optical appliance 10 in the hand. Orientation features 35 can take many different forms. Orientation feature 35 can be any type of embossing, texture, contour, bumps, protuberances, etc, which can be felt with the fingers. It is to be understood, however, that optical appliance 10 in some embodiments does not include orientation features 35.

In the embodiment of optical appliance 10 show in FIG. 1 through FIG. 12, orientation feature 35 is an embossed alphabetical character, which in this embodiment is an embossed letter “D” 35. The alphabetical letter “D” provides particular advantages that enhance the usefulness and ease of orientation of optical appliance 10. The embossing can be felt with the fingers so that the user can determine the orientation of optical appliance 10 by touch. In this embodiment, orientation feature 35 includes protruding first and second serifs 137 and 138 (FIG. 2 and FIG. 3) of the letter “D,” which adds further tactile information and gripping capability. First serif 137 and second serif 138 of embossed letter “D” orientation feature 35 protrude from perimeter 15. Also in this embodiment, embossed letter “D” orientation feature 35 includes orientation feature opening 70. Orientation feature opening 70 is an opening through body portion 112 that is defined by inner perimeter 172 of embossed letter “D” 35. Opening 70 adds further tactile and gripping capabilities, plus it can be used to hang optical appliance 10 from a hook, snap, lanyard, or other hanging or carrying device.

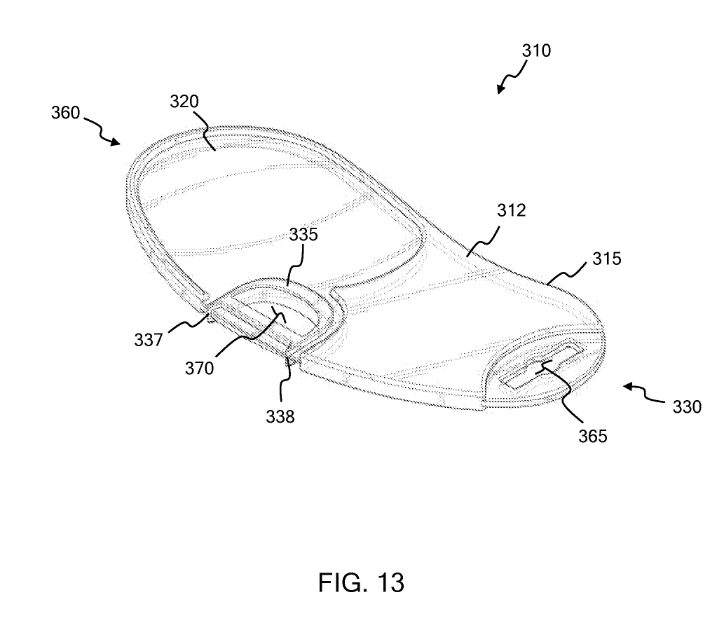

Body portion 112, according to the invention, can include other openings. In the embodiment shown, body portion 112 also includes strap mount opening 65 which can also be used for hanging or carrying optical appliance 10. Strap mount opening 65 includes round hole 75 which can be used to run a chain, rope, keychain, or other hanger element through. In some embodiments optical appliance 10 does not include openings in body portion 112. In some embodiments, optical appliance 10 does not even include a lens opening, because in some embodiments the lens portion is molded together with the body portion, as shown in the embodiment of optical appliance 310 shown in FIG. 13.

Body portion 112 is thin in side view cross section, as shown in FIG. 4 through FIG. 6 and FIG. 10 and FIG. 11. This thin kidney/disc shape of body portion 112 allows optical appliance 10 to fit in the credit card slot of a wallet or purse, for example. Optical appliance 10 is sized and shaped to fit in a pocket, and to be removed and used discreetly. Optical appliance 10 can be fitted into the credit card slot of a restaurant guest check presenter, for example.

Body portion 112, according to the invention of FIG. 1 through FIG. 10, includes lens opening 116. In this embodiment body portion 112 and lens portion 20 are separate elements which couple together. In some embodiments, body portion 112 and lens portion 20 are molded as one piece (see FIG. 13 for example). In the embodiment of optical appliance 10 shown in the figures, lens opening 116 extends through body portion 112 from top surface 132 to bottom surface 134. Lens opening 116 is defined by lens opening perimeter 122. Body portion 112 also includes top and bottom lens retention ridges 118 and 119 as shown in FIG. 9 through FIG. 12. In some embodiments, body portion 112 includes one top lens retention ridge 118 and one bottom lens retention ridge 119. Top lens retention ridge 118 is coupled to lens opening perimeter 122. Bottom lens retention ridge 119 is coupled to lens opening perimeter 122. Lens portion 20 is coupled to body portion 112 in response to lens retention rim 152 being positioned between top lens retention ridge 118 and bottom lens retention ridge 119 as explained below.

In the embodiment of optical appliance 10 shown in FIG. 9, body portion 112 includes three top lens retention ridges 118, which include first top lens retention ridge 118a, second top lens retention ridge 118b, and third top lens retention ridge 118c. First top lens retention ridge 118a, second top lens retention ridge 118b, and third top lens retention ridge 118c are spaced along lens opening perimeter 122 as shown in FIG. 9.

In the embodiment of optical appliance 10 shown in FIG. 9, body portion 112 includes three bottom lens retention ridges 119, which include first bottom lens retention ridge 119a, second bottom lens retention ridge 119b, and third bottom lens retention ridge 119c. First bottom lens retention ridge 119a, second bottom lens retention ridge 119b, and third bottom lens retention ridge 119c are spaced along lens opening perimeter 122 as shown in FIG. 9.

Top lens retention ridges 118a, 118b, and 118c are alternatingly positioned along lens opening perimeter 122 with bottom lens retention ridges 119a, 119b, and 119c as shown in FIG. 9. FIG. 9 shows a front view of a portion of body portion 112, showing the alternating placement of top lens retention ridges 118a, 118b, and 118c, and bottom lens retention ridges 119a, 119b, and 119c. Top lens retention ridges 118a, 118b, and 118c and bottom lens retention ridges 119a, 119b, and 119c do not overlap each other (also see FIG. 12), but they extend along the complete lens opening perimeter 122. When a top lens retention ridge 118 ends, a bottom lens retention ridge 119 begins, and vice versa. In this embodiment, lens portion 20 is coupled to body portion 112 in response to lens retention rim 152 being positioned between top lens retention ridges 118a, 118b, and 118c and bottom lens retention ridges 119a, 119b, and 119c. Top lens retention ridges 118a, 118b, and 118c prevent lens portion 20 from exiting lens opening 116 towards top surface 132. Bottom lens retention ridges 119a, 119b, and 119c prevent lens portion 20 from exiting lens opening 116 towards bottom surface 134, as shown in FIG. 11.

Top lens retention ridges 118a, 118b, and 118c are coupled to lens opening perimeter 122. In this embodiment top lens retention ridges 118a, 118b, and 118c are formed as an integral part of lens opening perimeter 122. Top lens retention ridges 118a, 118b, and 118c are positioned on lens opening perimeter 122 closer to top surface 132 than bottom surface 134, as can be seen in FIG. 10 through FIG. 12. FIG. 10 shows that top lens retention ridge 118a is positioned distance D₁ from top surface 132, and distance D₂ from bottom surface 134. Distances D₁ and D₂ are measured from approximately the center of top lens retention ridge 118a to top surface 132 and bottom surface 134 respectively. Distance D₁ is smaller than distance D₂, resulting in top lens retention ridges 118, including 118a, 118b, and 118c being positioned on lens opening perimeter 122 closer to top surface 132 than bottom surface 134. Top lens retention ridges 118a, 118b, and 118c are placed closer to top surface 132 so that once lens portion 20 is positioned between top lens retention ridges 118 and bottom lens retention ridges 119, lens portion 20 is prevented from moving towards top surface 132 and being removed from lens opening 116 by top lens retention ridges 118a, 118b, and 118c.

FIG. 12 shows a close-up view of a part of body portion 112, showing top lens retention ridge 118c and bottom lens retention ridges 119b and 119c, illustrating the alternating placement of top lens retention ridge 118c and bottom lens retention ridges 119b and 119c. FIG. 12 also shows that top lens retention ridge 118c is positioned on lens opening perimeter 122 closer to top surface 132 than bottom surface 134, and that bottom lens retention ridges 119b and 119c are positioned on lens opening perimeter 122 closer to bottom surface 134 than to top surface 132.

Bottom lens retention ridges 119a, 119b, and 119c are coupled to lens opening perimeter 122. In this embodiment, bottom lens retention ridges 119a, 119b, and 119c are formed as an integral part of lens opening perimeter 122. Bottom lens retention ridges 119a, 119b, and 119c are positioned on lens opening perimeter 122 closer to bottom surface 134 than top surface 132, as can be seen in FIG. 10 through FIG. 12. FIG. 10 shows that bottom lens retention ridge 119b is positioned distance D₃ from bottom surface 134, and distance D₄ from top surface 132. Distances D₃ and D₄ are measured from approximately the center of bottom lens retention ridge 119b to bottom surface 134 and top surface 132 respectively. Distance D₃ is smaller than distance D₄, resulting in bottom lens retention ridges 119, which includes bottom lens retention ridges 119a, 119b, and 119c, being positioned on lens opening perimeter 122 closer to bottom surface 134 than top surface 132. Bottom lens retention ridges 119a, 119b, and 119c are located closer to bottom surface 134 so that once lens portion 20 is positioned between top lens retention ridges 118 and bottom lens retention ridges 119, lens portion 20 is prevented from moving towards bottom surface 134 and being removed from lens opening 116 by bottom lens retention ridges 119a, 119b, and 119c.

Lens portion 20 is coupled to body portion 112 in response to lens retention rim 152 being placed in between top lens retention ridges 118 and bottom lens retention ridges 119. In this embodiment, lens portion 20 is coupled to body portion 112 in response to lens retention rim 152 being placed in between top lens retention ridges 118a, 118b, and 118c and bottom lens retention ridges 119a, 119b, and 119c. Lens retention rim 152 is positioned in space S between top lens retention ridges 118a, 118b, and 118c and bottom lens retention ridges 119a, 119b, and 119c (See FIG. 12).

Top lens retention ridges 118 and bottom lens retention ridges 119 have different depths in this embodiment, as illustrated in FIG. 9. Top lens retention ridges 118a, 118b, and 118c protrude a depth D_{T} from lens opening perimeter 122. Bottom lens retention ridges 119a, 119b, and 119c protrude a depth D_{B} from lens opening perimeter 122. In this embodiment, top lens retention ridge depth D_{T} is smaller than bottom lens retention ridge depth D_{B}, but this is not mean to be limiting. FIG. 9 shows a portion of body portion 112 and lens opening 116, with the depths D_{T} and D_{B} shown larger than actual size and not actual scale in order to illustrate the relative size differences between top lens retention ridges 118 and bottom lens retention ridges 119 in this embodiment. In this embodiment, height Hᵣᵢₘ is approximately equal to depth D_{B}, but this is not meant to be limiting. In some embodiments, bottom lens retention ridges 119a, 119b, and 119c have a depth D_{B} of between 0.015 inches and 0.025 inches. In the embodiment shown, bottom lens retention ridges 119a, 119b, and 119c have a depth of about 0.020 inches, within manufacturing tolerances. In some embodiments, top lens retention ridges 118a, 118b, and 118c have a depth D_{T} of between 0.005 inches and 0.015 inches. In the embodiment shown, top lens retention ridges 118a, 118b, and 118c have a depth of about 0.010 inches, within manufacturing tolerances.

FIG. 10 and FIG. 11 show a side view cross section of body portion 112 and lens portion 20, including top lens retention ridge 118a and bottom lens retention ridge 119b. FIG. 10 and FIG. 11 illustrate lens portion 20 being snapped into and coupled with body portion 112. Lens portion 20 is coupled with body portion 20 by snapping lens portion 20 over top lens retention ridge 118a so that it comes to rest against bottom lens retention ridge 119b. Having top lens retention ridge depth D_{T} smaller than bottom lens retention ridge depth D_{B} allows lens retention rim 152 to snap over top lens retention ridges 118 more easily than over bottom lens retention ridges 119. In this way, lens portion 20 can be snapped into lens opening 116 of body 112 by pushing lens retention rim 152 over top lens retention ridges 118a, 118b, and 118c, and securely against bottom lens retention ridges 119a, 119b, and 119c, so that lens retention rim 152 sits in space S between top lens retention ridges 118 and bottom lens retention ridges 119 (see FIG. 12 for space S). Also in this way, lens 20 is coupled to body portion 112 in response to lens retention rim 152 being placed between at least one top lens retention ridge 118 and at least one bottom lens retention ridge 119. In the embodiment of optical appliance 10 shown in the figures, lens portion 20 is coupled to body portion 112 in response to lens retention rim 152 being placed between top lens retention ridges 118a, 118b, and 118c and bottom lens retention ridges 119a, 119b, and 119c.

It is to be understood that lens retention ridges 118 and 119 can take many sizes and forms according to the invention. Top lens retention ridges 118 can have many sizes and forms. Bottom lens retention ridges 119 can have many sizes and forms. Lens retention rim 152 can have many sizes and forms that allow lens retention rim 152 to be placed between top lens retention ridge 118 and bottom lens retention rim 119, coupling lens portion 20 to body portion 112.

FIG. 13 shows a top perspective view of an embodiment of optical appliance 310, according to the invention. Optical appliance 310 is similar to optical appliance 10 and similar numbering corresponds to similar features. Optical appliance 310 includes body portion 312, lens portion 320, butt end 330, and distal end 360. Body portion 312 has perimeter 315 which is kidney-shaped in this embodiment. In this embodiment body portion 312 and lens portion 320 are formed of one piece. In this embodiment body portion 312 and lens portion 320 are molded in one piece. Optical appliance 310 includes orientation feature 325, with orientation feature opening 370 defined by the inner perimeter of orientation feature 335. Serifs 337 and 338 protrude from perimeter 315 for tactile feedback and gripping. Strap mount opening 365 can be used to hang or carry optical appliance 310 from a strap or chain.

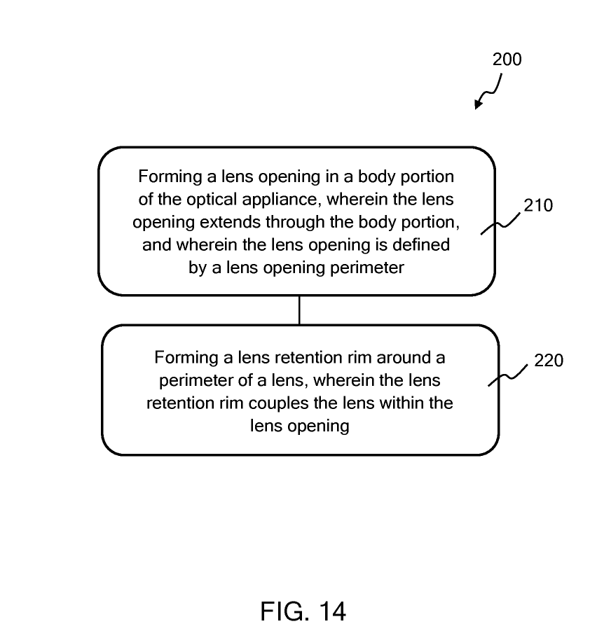

FIG. 14 shows method 200 of forming an optical appliance according to the invention. Method 200 of forming an optical appliance includes step 210 of forming a lens opening in a body portion of the optical appliance, where the lens opening extends through the body portion, and wherein the lens opening is defined by a lens opening perimeter. Method 200 of forming an optical appliance according to the invention also includes step 220 of forming a rim around a perimeter of a lens, where the rim couples the lens within the lens opening. Method 200 can include many other steps. In some embodiments, step 210 includes forming a lens opening in a body portion of the optical appliance, where a perimeter of the body portion is kidney-shaped. In some embodiments, step 210 includes forming a top lens retention ridge on the lens opening perimeter. In some embodiments, the top lens retention ridge is placed closer to a top surface of the body portion than a bottom surface of the body portion. In some embodiments, step 210 includes forming a bottom lens retention ridge on an inside perimeter of the lens opening. In some embodiments, the bottom lens retention ridge is placed closer to a bottom surface of the body portion than a top surface of the body portion.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. An optical appliance comprising:
a body portion, wherein a perimeter of the body portion is kidney-shaped; and
a lens portion coupled to the body portion, wherein a viewer looks through the lens portion to aid visual acuity.

2. The optical appliance of claim 1, wherein the body portion comprises an orientation feature.

3. The optical appliance of claim 2, wherein the orientation feature is an embossed alphabetical character.

4. The optical appliance of claim 3, wherein the embossed alphabetical character is a letter “D.”

5. The optical appliance of claim 4, wherein an orientation feature opening through the body portion is defined by an inner perimeter of the embossed letter “D.”

6. The optical appliance of claim 5, wherein a first and a second serif of the embossed letter “D” protrude from the perimeter of the body portion.

7. The optical appliance of claim 1, wherein the body portion further comprises a strap mount opening.

8. An optical appliance comprising:
a body portion, wherein the body portion comprises:
a lens opening extending through the body portion, wherein the lens opening is defined by a lens opening perimeter;
a top lens retention ridge coupled to the lens opening perimeter; and
a bottom lens retention ridge coupled to the lens opening perimeter; and
a lens portion comprising:
a lens perimeter; and
a lens retention rim coupled to the lens perimeter, wherein the lens portion is coupled to the body portion in response to the lens retention rim being positioned between the top lens retention ridge and the bottom lens retention ridge.

9. The optical appliance of claim 8, wherein the top lens retention ridge is a first top lens retention ridge, and wherein the body portion further comprises a second and a third top lens retention ridge coupled to the lens opening perimeter.

10. The optical appliance of claim 9, wherein the bottom lens retention ridge is a first bottom lens retention ridge, and wherein the body portion further comprises a second and a third bottom lens retention ridge coupled to the lens opening perimeter.

11. The optical appliance of claim 10, wherein the first, second, and third top lens retention ridges and the first, second, and third bottom lens retention ridges are alternatingly positioned along the lens opening perimeter.

12. The optical appliance of claim 8, wherein the top lens retention ridge has a top lens retention ridge depth, and wherein the bottom lens retention ridge has a bottom lens retention ridge depth, and wherein the top lens retention ridge depth is smaller than the bottom lens retention ridge depth.

13. A method of forming an optical appliance comprising:
forming a lens opening in a body portion of the optical appliance, wherein the lens opening extends through the body portion, and wherein the lens opening is defined by a lens opening perimeter; and
forming a lens retention rim on a perimeter of a lens, wherein the lens retention rim couples the lens within the lens opening.

14. The method of claim 13, wherein a perimeter of the body portion is kidney-shaped.

15. The method of claim 13, wherein forming a lens opening in a body portion of the optical appliance comprises forming a top lens retention ridge on the lens opening perimeter.

16. The method of claim 15, wherein the top lens retention ridge is placed on the lens opening perimeter closer to a top surface of the body portion than to a bottom surface of the body portion.

17. The method of claim 16, wherein the step of forming a lens opening in a body portion of the optical appliance further comprises forming a bottom lens retention ridge on the lens opening perimeter.

18. The method of claim 17, wherein the bottom lens retention ridge is placed on the lens opening perimeter closer to the bottom surface of the body portion than to the top surface of the body portion.

19. The method of claim 13, further comprising forming an orientation feature opening in the body portion, wherein the orientation feature opening is defined by the inner perimeter of an alphabetical character.

20. The method of claim 13, further comprising forming a strap mount opening in the body portion.
